(19) United States
(12) Patent Application Publication
(10) Pub. No.: US 2026/0091845 A1
(43) Pub. Date: Apr. 2, 2026

(54) DRIVE DEVICE FOR AN ELECTRIC BICYCLE AND ASSEMBLY FOR A DRIVE DEVICE

(71) Applicant: Porsche eBike Performance GmbH, Ottobrunn (DE)

(72) Inventors: Andreas Hoppe, Munich (DE); Harald Hobohm, Maulbronn (DE); Jörg Aniol, Leonberg (DE)

(21) Appl. No.: 19/339,072

(22) Filed: Sep. 24, 2025

(30) Foreign Application Priority Data
Sep. 30, 2024 (DE) 10 2024 128 282.7

(51) Int. Cl. B62M 6/60; F16H 1/28; F16H 57/08

(52) U.S. Cl. CPC B62M 6/60; F16H 1/2854; F16H 2057/085

(57) ABSTRACT

The drive device has a planetary gearbox with a planet carrier and a bevel gear stage with a first bevel gear. The planet carrier and the first bevel gear are coupled together in a rotationally fixed manner. The planet carrier and the first bevel gear are mounted rotatably about a rotational axis via a radial bearing. The radial bearing is supported by the planet carrier.

### CROSS-REFERENCE TO RELATED APPLICATIONS

This application claims priority of German patent application no. 10 2024 128 282.7, filed Sep. 30, 2024, the entire content of which is incorporated herein by reference.

### TECHNICAL FIELD

A drive device for an electric bicycle is described. In addition, an assembly for a drive device of an electric bicycle, a method for assembling a drive device of an electric bicycle, and an electric bicycle are described.

### BACKGROUND

Bicycles are a cost-effective, easy-to-use, and emission-free means of transportation. They have also become popular as sports and fitness equipment, and certain types have proven to be particularly suitable for various athletic applications.

In recent years, enthusiasm for electric bicycles (especially so-called “pedelecs”) has been growing, despite their high weight and price compared to conventional bicycles. In the case of electric bicycles, it is important to provide a reliable drive device.

### SUMMARY

One task to be solved is to specify a drive device for an electric bicycle that contributes to an efficient and low-wear operation of the electric bicycle. Further tasks to be solved are to specify an assembly for such a drive device, a method for assembling such a drive device, and an electric bicycle with such a drive device.

First, the drive device for an electric bicycle is specified.

In at least one embodiment, the drive device has a planetary gearbox with a planet carrier and a bevel gear stage with a first bevel gear. The planet carrier and the first bevel gear are coupled to each other in a rotationally fixed manner. The planet carrier and the first bevel gear are mounted rotatably about a rotational axis via a radial bearing. The radial bearing is supported by the planet carrier.

The present disclosure is based in particular on the realization that the performance of the drive device can be increased by precise and stable alignment of the intermeshing bevel gears of a bevel gear stage. During operation, the bevel gears are subjected to large forces, in particular a large tilting moment.

By using a radial bearing that is supported by the planet carrier rather than by the bevel gear, the tilting moment acting on the first bevel gear and the planet carrier can be absorbed particularly well. For example, the radial bearing can then be selected to be larger and thus also absorb greater loads than if it were supported by the first bevel gear. In addition, the radial bearing can be positioned further away from the interface between the bevel gears, which reduces the load on the radial bearing. This effectively counteracts tilting and radial displacement of the first bevel gear. Furthermore, the use of a radial bearing supported by the planet carrier helps to reduce tension due to tolerances.

In the drive device, the planet carrier and the first bevel gear are mounted rotatably about a rotational axis. This means, in particular, that the planet carrier and the first bevel gear can rotate relative to a housing of the drive device. Unless otherwise specified, here and in the following, directions parallel to the rotational axis of the planet carrier are referred to as “axial directions” or simply as “axial. ” In addition, unless otherwise indicated, the directional terms “radial” and “azimuthal” refer to this rotational axis. The planet carrier and/or the first bevel gear are, for example, formed to be rotationally symmetrical with respect to the rotational axis.

In addition to the planet carrier, the planetary gearbox includes a planet gear, which is rotatably mounted on the planet carrier, as well as a ring gear and a sun gear. The planet gear meshes with the sun gear and the ring gear. The ring gear can be connected to the housing in a rotationally fixed manner, meaning that it does not rotate during operation. The sun gear rotates, for example, about the same rotational axis as the planet carrier. The rotational axis of the planet gear runs parallel or essentially parallel to the rotational axis of the planet carrier. During operation, the rotational axis of the planet gear rotates around the rotational axis of the planet carrier. The planet carrier may be made of metal. The planet gear may be made partly of plastic.

For example, the planet gear is mounted rotatably relative to the planet carrier via a needle bearing. The use of a needle bearing is useful to counteract tilting of the planet gear relative to the planet carrier.

For the rotary mounting of the planet gear on the planet carrier, the planet gear may have a bolt or pin that is inserted through or into a recess in the planet carrier. Alternatively, the planet carrier may have a bolt or bushing that is inserted through a hole in the planet gear.

The planetary gearbox may have two or more, for example three, planet gears. The planet gears are then all rotatably mounted on the planet carrier. In particular, each of the planet gears is rotatably mounted on the planet carrier via a needle bearing. All features disclosed in connection with one planet gear are also disclosed for all further planet gears of the planetary gearbox.

The planet carrier and the first bevel gear are coupled together in a rotationally fixed manner. This means that, during normal operation, the planet carrier and the first bevel gear cannot rotate relative to each other around the rotational axis, but always rotate together at the same rotational speed.

The planet carrier and the first bevel gear are coupled together in a rotationally fixed manner, for example via a direct connection. The direct connection between the first bevel gear and the planet carrier can be a form-fitting and/or force-fitting connection. Alternatively, the rotationally fixed coupling could also be established with the aid of an auxiliary element, for example a screw and/or a nut.

The rotary mounting of the planet carrier and the first bevel gear is realized via a radial bearing. Only the one radial bearing can be used for the rotary bearing. However, it is preferable to use another bearing for the rotary mounting.

The radial bearing is supported by the planet carrier or, in other words, the planet carrier is supported in the radial bearing. This means that the radial bearing is arranged on or attached to the planet carrier and can be in direct contact with the planet carrier. For example, an inner ring of the radial bearing rests on the planet carrier and is in direct contact with it. Similarly, the additional bearing can be supported by the planet carrier, that is, it is arranged on or attached to the planet carrier and, in particular, is in direct contact with the planet carrier.

The first bevel gear, for example, does not carry a radial bearing, that is, there is no radial bearing arranged on or at the first bevel gear. A coupling of the first bevel gear to a radial bearing is, for example, established exclusively via the planet carrier.

The bevel gear stage also includes a second bevel gear which meshes with the first bevel gear. During operation, the second bevel gear rotates, for example, about a rotational axis which runs at an angle or perpendicular to the rotational axis of the planet carrier or the first bevel gear. The bevel gear stage is, for example, a 90° bevel gear stage. The first bevel gear is, for example, a bevel pinion. The second bevel gear is, for example, a ring gear.

According to at least one embodiment, a section of the first bevel gear is embedded in the planet carrier. The section is thus conformably enclosed by the planet carrier. In other words, the planet carrier surrounds the section of the first bevel gear flush or in a form-fitting manner. The embedding establishes the connection between the planet carrier and the first bevel gear. In particular, the connection is not releasable or cannot be released without destruction. The section of the first bevel gear is, for example, a pin-shaped section, for example cylindrical or conical section.

The section of the first bevel gear can be enclosed by the planet carrier by forming or by primary shaping, in particular by forging, casting, injection molding, or sintering. The planet carrier can be at least partially a primary shaped part, in particular a cast part, injection-molded part, or sintered part, that is, it is at least partially manufactured by casting, in particular metal casting, or by injection molding or sintering.

According to at least one embodiment, the connection between the first bevel gear and the planet carrier is a force-fitting and/or form-fitting connection. For example, the connection is purely force-fitting or purely form-fitting or purely force-and form-fitting.

The first bevel gear and the planet carrier connected to it can form a form-fitting connection in the circumferential direction in order to ensure reliable torque transmission during operation and to be able to transmit a higher torque than with a purely force-fitting connection. Alternatively or additionally, the first bevel gear and the planet carrier can also form a force-fitting connection in the axial direction. For example, the section of the first bevel gear embedded in the planet carrier or the planet carrier has at least one groove into which a rib of the planet carrier or the first bevel gear protrudes. The depth of the groove or the height of the rib is an extension in the radial direction. The groove and the rib extend, for example, in the axial direction. The embedded section of the first bevel gear may also have a knurled surface.

According to at least one embodiment, the connection between the first bevel gear and the planet carrier is partially or completely material-locked. The material lock may therefore be additional to or alternative to the force-fit and/or form-fit. The material-lock can result from the forming or primary shaping.

According to at least one embodiment, the planet carrier and the first bevel gear are directly connected to each other via a screw connection. For example, the first bevel gear is screwed into the planet carrier or vice versa. A screw connection offers the advantage that no further components are required for the connection.

Alternatively, it is also conceivable that the first bevel gear and the planet carrier are coupled together in a rotationally fixed manner via a spline connection, whereby the plug connection is secured via an additional screw and/or nut. For the spline connection, the planet carrier and/or the first bevel gear may have an axially and/or radially extending spline toothing. Alternatively, the first bevel gear and the planet carrier could be connected to each other in a purely force-fitting manner, with the force-fitting connection being established with the aid of an auxiliary element, for example a screw and/or nut.

According to at least one embodiment, the first bevel gear has an external thread for the screw connection. Accordingly, the planet carrier has an internal thread for the screw connection. In particular, the planet carrier includes a recess, for example a hole, into which the first bevel gear is screwed. The internal thread of the planet carrier is then provided in the area of the recess. The recess extends, for example, in the axial direction, with the rotational axis of the planet carrier running within the recess. The recess may be cylindrical in shape. The z-axis of the associated cylinder runs, for example, parallel to the rotational axis of the planet carrier or coincides with it. The thread of the first bevel gear is, for example, a left-hand thread in order to prevent the screw connection from loosening during operation.

The first bevel gear has, for example, a pin-shaped or cylindrical section that includes the external thread and is screwed into the recess. The toothing of the first bevel gear that is in mesh with the toothing of the second bevel gear is arranged outside the recess of the planet carrier.

According to at least one embodiment, the first bevel gear is centered relative to the planet carrier via a centering collar. The planet carrier and/or the first bevel gear may have a centering collar for centering. The centering collar is a section, for example an edge or a projection, of the planet carrier and/or of the first bevel gear, at which the planet carrier and the first bevel gear engage with each other, whereby the planet carrier and the first bevel gear are axially and/or radially aligned or centered with respect to each other. The planet carrier and the first bevel gear are, for example, in direct contact at the centering collar and may also be pressed against each other (press fit).

A surface of the centering collar at which the planet carrier and the first bevel gear are in direct contact is at least partially radially orientated, that is, a normal to this surface has a radial component. In particular, the planet carrier and the first bevel gear are radially aligned or centered relative to each other via the centering collar.

The centering collar is, for example, a section of the planet carrier in the area of the recess. For example, a tooth of the toothing of the first bevel gear is in direct contact with the planet carrier at the centering collar of the planet carrier. The toothing of the first bevel gear refers here and in the following to the toothing for meshing with the second bevel gear.

According to at least one embodiment, the centering collar is cylindrical. This means that a surface of the centering collar at which the planet carrier and the first bevel gear are in direct contact and, if applicable, pressed against each other, is cylindrical. The z-axis of the associated cylinder runs, for example, parallel to the rotational axis of the planet carrier or coincides with it.

According to at least one embodiment, a diameter of the centering collar is at least as large as a diameter of the toothing of the first bevel gear. For example, a diameter of the centering collar is at least as large as the maximum diameter of the toothing of the first bevel gear.

According to at least one embodiment, a diameter of the centering collar is larger than a diameter of the thread of the planet carrier for the screw connection. In particular, the mean diameter of the centering collar is larger than the mean diameter of the thread of the planet carrier.

For example, a diameter of the centering collar is at least 1.2 times or at least 1.5 times as large as a diameter of the thread of the planet carrier. The thread of the planet carrier or of the first bevel gear has, for example, a diameter of at least 10 mm and/or at most 18 mm, for example 14 mm. The diameter of the centering collar is, for example, at least 15 mm and/or at most 25 mm, for example 19.5 mm.

By choosing a centering collar with a large diameter, the first bevel gear can be aligned and mounted with particular precision and stability in relation to the planet carrier.

According to at least one embodiment, the centering collar is arranged axially between the interface of the screw connection and the interface between the first bevel gear and the second bevel gear. The interface of the screw connection is the area in which the threads of the planet carrier and of the first bevel gear engage with each other. The interface between the first bevel gear and the second bevel gear is the area in which the toothing of the two bevel gears engage with each other. The relative arrangement described helps to make optimum use of the available installation space.

According to at least one embodiment, the centering collar is conically shaped at least in sections. In particular, a surface of the centering collar at which the planet carrier and the first bevel gear are in direct contact and, if applicable, pressed against each other has the shape of a conical surface. Such a centering collar allows a press fit between the planet carrier and the first bevel gear to be easily created.

According to at least one embodiment, the planet carrier and the first bevel gear are press-fitted together in the area of the centering collar. This means that the first bevel gear and the planet carrier are pressed against each other at the centering collar. Such a press fit can be created, for example, by applying increased force when screwing the planet carrier and the first bevel gear together.

According to at least one embodiment, the radial bearing is located at least in sections at the same height as the ring gear of the planetary gearbox in the radial direction. This means that there is an area of the radial bearing, for example the outer ring, in which the radial bearing is spaced in the radial direction from the rotational axis of the planet carrier by the same distance as an area of the ring gear, for example the teeth of the ring gear. Alternatively or additionally, the radial bearing can be located at least in sections at the same height as the at least one planet gear of the planetary gearbox in the radial direction. In particular, the radial bearing protrudes beyond the at least one planet gear in the radial direction. For example, the radial bearing also protrudes beyond the planet carrier in the radial direction.

A radial bearing selected to be this large provides particularly good support for the planet carrier and thus for the first bevel gear against tilting.

According to at least one embodiment, the radial bearing is coupled both directly to the planet carrier and directly to the housing of the drive device. In particular, the radial bearing adjoins the housing and the planet carrier in the radial direction. For example, an outer ring of the radial bearing adjoins the housing in the radial direction and an inner ring of the radial bearing adjoins the planet carrier in the radial direction. In the area where the radial bearing adjoins the housing in the radial direction, the housing is formed with a single wall, for example, and its surface opposite the radial bearing forms an outer surface of the drive device.

Because the radial bearing adjoins both the housing and the planet carrier in the radial direction, the tolerance chain in the radial direction is also kept small, which also keeps the maximum tilt angle of the planet carrier small.

According to at least one embodiment, the drive device further includes an axial bearing, via which the planet carrier and the first bevel gear are rotatably mounted. The axial bearing is particularly effective at absorbing axially acting forces. For example, the axial bearing can absorb the forces acting due to the tilting moment.

The radial bearing and the axial bearing are arranged in particular at axially opposite areas of the planet carrier, that is, the planet carrier is, in the axial direction, arranged in sections between the radial bearing and the axial bearing.

According to at least one embodiment, the axial bearing has elongated rolling elements. The longitudinal axis of the rolling elements runs, for example, in the radial direction in each case. The rolling elements of the axial bearing can be cylindrical or conical. The axial bearing can be a needle bearing. The radial bearing is, for example, a ball bearing.

According to at least one embodiment, the axial bearing is arranged in the radial direction on the outer circumference of the planet carrier. This means that the axial bearing is arranged as far away as possible from the rotational axis of the planet carrier on the planet carrier. This results in a particularly large support width of the axial bearing.

According to at least one embodiment, the axial bearing and the planet gear of the planetary gearbox are at least partially at the same height in the radial direction. In other words, there is a region of the axial bearing that is spaced just as far in the radial direction from the rotational axis of the planet carrier as a region of the at least one planet gear. In particular, the axial bearing is further away from the rotational axis of the planet carrier in the radial direction than the rotational axis of the planet gear. Alternatively or additionally, the axial bearing and the ring gear of the planetary gearbox are, at least in sections, located at the same height in the radial direction.

According to at least one embodiment, the axial clearance of the planet carrier in the drive device is at most 0.3 mm or at most 0.2 mm or at most 0.1 mm. This means that during operation, the planet carrier can be displaced in a direction parallel to the rotational axis by at most 0.3 mm or at most 0.2 mm or at most 0.1 mm. Such a small axial clearance of the planet carrier also keeps the maximum angle by which the planet carrier can tilt during operation small. Such a small axial clearance can be achieved in particular by a small tolerance chain in the axial direction. Axial movement of the planet carrier is limited by stops provided on both sides of the planet carrier in the axial direction.

According to at least one embodiment, a thrust washer of the axial bearing is directly opposite a support element of the drive device in the axial direction. The support element forms, for example, one of the two stops mentioned above. For example, the support element is a section of the housing or is fixed with respect to the housing, that is, arranged immovably relative to the housing. The support element can, in particular, be a radially extending section of the housing. The thrust washers are the washers of the axial bearing on which the rolling elements of the axial bearing roll.

The fact that two elements are opposite each other in the axial direction means that, when viewed parallel to the rotational axis of the planet carrier, one element at least partially covers the other element. In other words, the two elements are at the same height, at least in sections, both in the radial direction and in the azimuthal direction. The fact that the elements are directly opposite each other means that, apart from at most a gap filled with air or lubricant, no other element, in particular no other solid body of the drive device, is arranged between them.

According to at least one embodiment, a further thrust washer of the axial bearing is directly opposite the planet carrier in the axial direction. In particular, the planet carrier is spaced apart from the support element in the axial direction by the axial bearing.

According to at least one embodiment, a ring of the radial bearing is directly opposite a further support element of the drive device in the axial direction. The further support element forms the other of the two stops mentioned above. In particular, the further support element is a section of the housing or is fixed with respect to the housing, that is, arranged immovably relative to the housing. The further support element is, for example, a radially extending housing section. The ring is, in particular, the outer ring of the radial bearing. The rolling elements of the radial bearing run on the ring.

According to at least one embodiment, another ring of the radial bearing is directly opposite the planet carrier in the axial direction. The other ring is, in particular, the inner ring of the radial bearing. The other ring may be spaced apart from the planet carrier by an O-ring. The rolling elements of the radial bearing run on the additional ring.

According to at least one embodiment, some or all of the aforementioned elements directly opposite each other adjoin each other. At least, the sum of the axial distances between the aforementioned elements directly opposite each other is at most 0.3 mm or at most 0.2 mm or at most 0.1 mm. Because only the axial bearing and the radial bearing are arranged axially between the planet carrier and the two support elements, the tolerance chain in the axial direction is kept small, thereby achieving low axial play of the planet carrier.

According to at least one embodiment, the radial bearing is arranged axially between the axial bearing and the second bevel gear. In particular, the radial bearing is arranged in the axial direction at least in sections at the height of the planet carrier.

According to at least one embodiment, the planet gear is arranged axially between the radial bearing and the axial bearing.

According to at least one embodiment, the support width of the axial bearing is greater than the axial distance of the radial bearing to the interface of the bevel gears of the bevel gear stage. This serves in particular to keep the axial forces absorbed by the axial bearing as low as possible. The interface of the bevel gears is understood here to be the area in which the toothing of the two bevel gears mesh with each other.

According to at least one embodiment, the inner diameter of the radial bearing is greater than the inner diameter of the axial bearing. For example, the inner diameter of the radial bearing is at least 4 cm or at least 5 cm.

By positioning the radial bearing far away from the rotational axis, the planet carrier can be precisely aligned and held stable in its radial position during operation. A large radial bearing also helps to counteract tilting.

According to at least one embodiment, the drive device further includes an electric motor and an output. The electric motor is coupled to the output via the planetary gearbox to transmit torque from the electric motor to the output.

In other words, the planetary gear is connected between the electric motor and the output drive. The planetary gearbox is specifically configured to increase the torque delivered by the electric motor. For example, the planetary gearbox is arranged axially between the electric motor and the output.

The electric motor includes a stator and a rotor. For example, the electric motor is an internal rotor motor.

The output is the component of the drive device from which torque is diverted from the drive device. For example, the output includes an output shaft. The output shaft may be a hollow shaft. For example, a pedal axle of the drive device runs through the output shaft. The output shaft may be connected in a rotationally fixed manner to a chainring or a chainring spider. Alternatively or additionally, the output shaft has an interface for a coupling to a chainring or a chainring spider.

According to at least one embodiment, the bevel gear stage couples the planetary gearbox to the output. In other words, the bevel gear stage is connected between the planetary gearbox and the output. The bevel gear stage is, for example, configured to further increase the torque delivered by the planetary gearbox. The planetary gearbox is, for example, arranged axially between the electric motor and the bevel gear stage.

According to at least one embodiment, the second bevel gear is coupled to the output without an intermediate gear stage. The rotational axis of the planet carrier lies, for example, in a plane that is perpendicular to the rotational axis of the output. The rotational axis of the output is, for example, parallel or identical to the rotational axis of the second bevel gear. The drive device is, for example, an orthogonal drive.

According to at least one embodiment, the second bevel gear is coupled to the output via a freewheel. For example, the freewheel couples the second bevel gear to the output shaft of the output.

According to at least one embodiment, the output shaft of the output is coupled to a pedal shaft of the drive device via a freewheel. The freewheel is, for example, a toothed disc freewheel. In particular, the pedal shaft is passed through the output shaft, wherein the output shaft is formed as a hollow shaft.

According to at least one embodiment, the pedal shaft extends obliquely or perpendicularly to the rotational axis of the planet carrier. In other words, a rotational axis of the pedal shaft is inclined or perpendicular to the rotational axis of the planet carrier. For example, the angle between the pedal shaft or the rotational axis of the pedal shaft and the rotational axis of the planet carrier is between 80° and 100° inclusive.

Next, the electric bicycle is described. The electric bicycle includes a drive device according to one of the embodiments described here.

Next, the assembly for a drive device of an electric bicycle and the method for assembling a drive device are specified. In particular, the assembly is configured for assembling a drive device according to one of the embodiments described herein. In this respect, all features disclosed in connection with the drive device are also disclosed for the assembly and the method, and vice versa.

In at least one embodiment, the assembly for a drive device of an electric bicycle includes a planet carrier for a planetary gearbox and a first bevel gear for a bevel gear stage. The planet carrier and the first bevel gear are coupled to each other in a rotationally fixed manner. The planet carrier and the first bevel gear are mounted rotatably about a rotational axis via a radial bearing. The radial bearing is supported by the planet carrier.

In addition to the planet carrier, the radial bearing, and the first bevel gear, the assembly may include a housing part, for example a bottom bracket housing. The planet carrier and the first bevel gear are mounted so that they can rotate relative to this housing part. The housing part of the assembly can be connected to one or more other housing parts of one or more other assemblies to form a housing for the drive device. Furthermore, the assembly can have at least one planet gear and one ring gear. In addition, the assembly may include an axial bearing, with the aid of which the planet carrier and the first bevel gear can also be mounted rotatably. Furthermore, the assembly may include a pedal shaft.

The further assembly includes, for example, the output and the second bevel gear coupled thereto for the bevel gear stage. The further assembly also includes a housing part, for example a cover.

Yet another assembly includes, for example, an electric motor with a stator, a rotor, and a motor shaft. The yet another assembly may include the support element for the thrust washer of the axial bearing. Furthermore, the yet another assembly includes a housing part, for example a motor housing.

In at least one embodiment, the assembly and the further assembly are connected to each other for the assembling of the drive device, in particular by connecting their housing parts to each other, for example by screwing them together. In addition, the bevel gears of the assembly and the further assembly are brought into engagement with each other. Furthermore, for example, the pedal shaft of the assembly is pushed through the output shaft of the further assembly.

According to at least one embodiment, the assembly is connected to the yet another assembly in the method. In particular, the housing parts are connected to each other. In doing so, the support element of the yet another assembly, which is formed, for example, by the housing part of the yet another assembly, is arranged axially directly opposite the thrust washer of the axial bearing. The motor shaft can be inserted through the planet carrier during assembly.

Hereinafter, the drive device described herein, the assembly described herein, the method for assembling a drive device described herein, and the electric bicycle described herein are explained in more detail with reference to drawings on the basis of exemplary embodiments. The same reference signs indicate the same elements in the individual figures. Insofar as elements or components in the various figures are identical in function, their description is not repeated for each of the following figures. For reasons of clarity, elements may not be provided with respective reference signs in all figures.

### BRIEF DESCRIPTION OF DRAWINGS

The invention will now be described with reference to the drawings wherein:

FIG. 1 shows an embodiment of the electric bicycle;

FIG. 2 shows an embodiment of the drive device;

FIG. 3 shows another embodiment of the drive device;

FIG. 4 shows a detail from FIG. 3;

FIGS. 5 to 10 show further embodiments of the drive device;

FIG. 11 shows a detail from another embodiment of the drive device;

FIG. 12 shows an embodiment of the assembly;

FIG. 13 shows an embodiment of the yet another assembly;

FIG. 14 shows a position in an embodiment of the assembly method;

FIG. 15 shows an embodiment of the further assembly;

FIG. 16 shows a further position in an embodiment of the assembly method; and,

FIG. 17 shows a further embodiment of the drive device.

### DETAILED DESCRIPTION

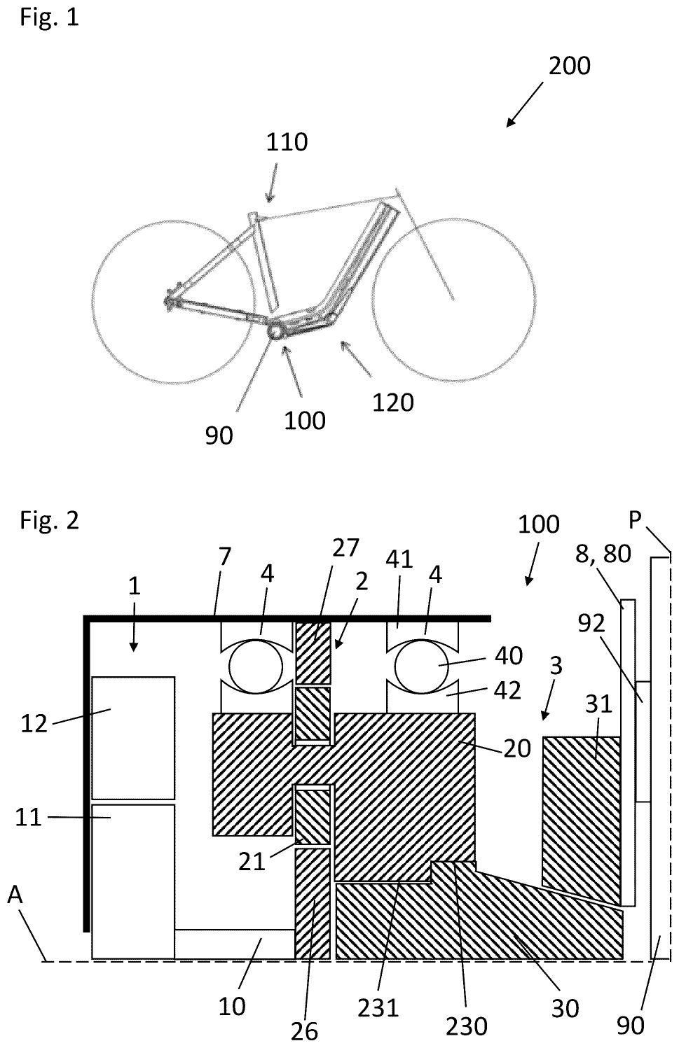

FIG. 1 schematically shows an electric bicycle 200 with a bicycle frame 110, which has a lower frame section 120. This forms a down tube. The lower frame section 120 extends toward a bottom bracket of the electric bicycle, wherein the bottom bracket includes a pedal shaft 90. The pedal shaft 90 is part of a drive device 100 installed in the bicycle.

FIG. 2 shows a first embodiment of the drive device 100 in a cross-sectional view. The drive device 100 has a planetary gearbox 2. The planetary gearbox 2 includes a planet carrier 20, which is mounted in a housing 7 so that it can rotate about a rotational axis A. One or more planet gears 21 are mounted on the planet carrier 20 so that they can rotate relative to the planet carrier 20. FIG. 2 shows only the part of the drive device 100 above the rotational axis A.

The planetary gearbox 2 also includes a sun gear 26. The at least one planet gear 21 is in meshed engagement with the sun gear 26, which is also mounted so as to be rotatable about the rotational axis A, for example. In addition, at least one planet gear 21 is in meshed engagement with a ring gear 27 of the planetary gearbox 2. The ring gear 27 can be mounted so as to be rotatable about the rotational axis A or can be connected to the housing 7 in a rotationally fixed manner, that is, it can be mounted so as to be non-rotatable.

The planetary gearbox 2 couples an electric motor 1 to an output 8 via an intermediate bevel gear stage 3. The electric motor 1 includes a rotor 11 and a stator 12. A motor shaft 10 of the electric motor 1 is connected to the sun gear 26 of the planetary gearbox 2 in a rotationally fixed manner. Alternatively, the motor shaft 10 can also be connected to the ring gear 27 in a rotationally fixed manner. The output 8 is connected to a second bevel gear 31 of the bevel gear stage 3 in a rotationally fixed manner. In particular, an output shaft 80 of the output 8, which is formed as a hollow shaft 80, is connected in a rotationally fixed manner to the bevel gear 31 and, for example, to a chainring or a chainring spider (not shown).

The planet carrier 20 is connected in a rotationally fixed and direct manner to a first bevel gear 30 of the bevel gear stage 3. This coupling is established via a screw connection 231. A pin-shaped section of the first bevel gear 30 is screwed into a recess in the planet carrier 20. The pin-shaped section has an external thread, and the recess in the planet carrier is limited by an internal thread. The threads are, for example, M14 threads.

A cylindrical centering collar 230 is provided for centering the first bevel gear 30 with respect to the planet carrier 20. The diameter of the centering collar 230 is, for example, 19.5 mm.

During operation, the planet carrier 20 and the first bevel gear 30 rotate together around the rotational axis A. The first bevel gear 30 meshes with the second bevel gear 31 of the bevel gear stage, which rotates around the rotational axis P during operation.

The planetary gearbox 2 and the bevel gear stage 3 are used in the drive device 100 to transmit torque from the electric motor 1 to the output 8. With the help of the planetary gearbox 2 and the bevel gear stage 3, the speed is reduced and the torque is increased in particular. The transmitted torque can be used to assist the pedaling motion of a rider of the electric bicycle. In this case, the pedal shaft 90, on which the rider manually exerts torque, is coupled to the output shaft 80 via a freewheel 92, so that both the torque exerted by the rider and the torque exerted by the electric motor 1 can be transmitted to the output 8.

The rotary bearing of the planet carrier 20 in the housing 7 is realized via two radial bearings 4, both of which are carried by the planet carrier 20. The radial bearings 4 each include an inner ring 42 resting on the planet carrier, rolling elements 40, for example in the form of balls, and an outer ring 41. The outer ring 41 adjoins the housing 7 in the radial direction.

Due to the described arrangement of the first bevel gear 30, which is directly coupled to the planet carrier 20, and the mounting of the planet carrier 20 and the first bevel gear 30 via bearings 4, which are not supported by the first bevel gear 30 but by the planet carrier 20, the first bevel gear 30 can be positioned with particular precision and stability and is well protected against tilting during operation.

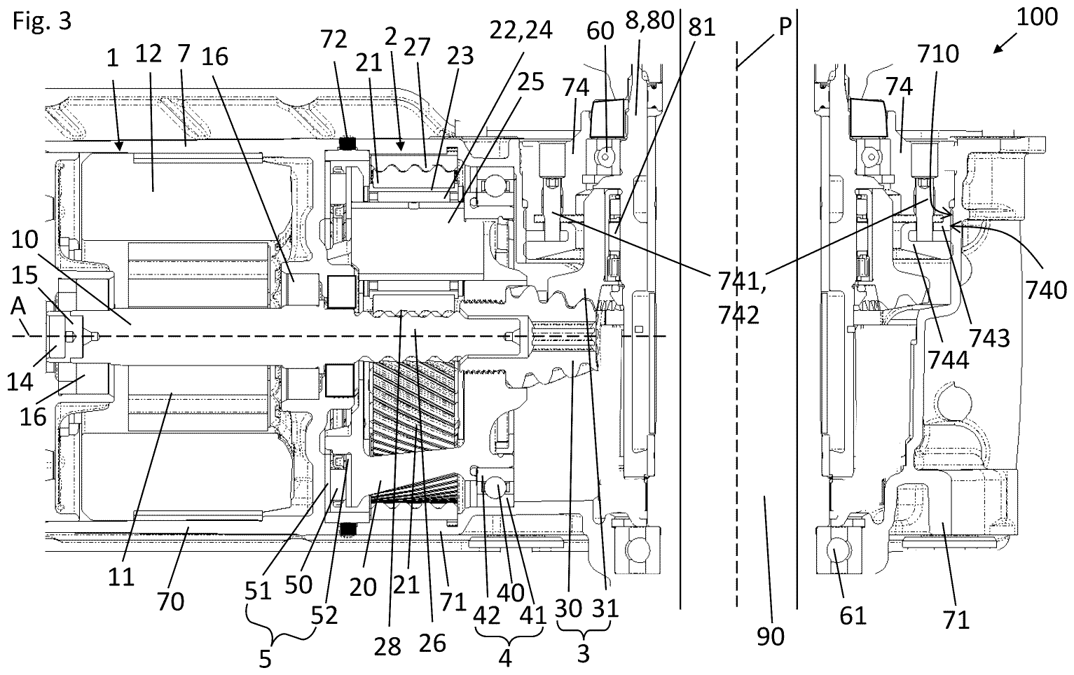

FIG. 3 shows a further embodiment of the drive device 100 in a cross-sectional view. The drive device 100 includes a housing 7 with three interconnected housing parts 70, 71, 74. The housing part 70 forms a motor housing in which an electric motor 1 is accommodated. The housing part 71 forms a bottom bracket housing in which, among other things, a planetary gearbox 2 is accommodated. The motor housing 70 and the bottom bracket housing 71 are connected to each other via a sealing sleeve 72. The housing part 74 forms an output-side cover that is screwed onto the bottom bracket housing 71.

The electric motor 1 includes a stator 12 and a rotor 11. The electric motor 1 is an internal rotor motor. During operation, the rotor 11 rotates relative to the stator 12 or the housing 7 about a rotational axis A. The rotor 11 is coupled to a motor shaft 10 and also causes it to rotate about the rotational axis A during operation. The rotational axis A runs through the motor shaft 10. The motor shaft 10 is made of stainless steel or case-hardened steel, for example. The electric motor 1 is mounted in the housing 7 via motor bearings 16.

The motor shaft 10 protrudes in an axial direction from the rotor 11 and into the planet carrier 20 of the planetary gearbox 2. In the opposite axial direction, a magnet 14 is arranged at the end of the motor shaft 10, which is spaced from the motor shaft 10 by an adapter 15. The adapter 15 is made of aluminum, for example, and is intended to reduce the influence of the steel motor shaft 10 on the magnetic field generated by the magnet 14. The drive device 100 further includes a sensor (not shown) which detects the magnetic field of the magnet 14 and thereby detects the position of the motor shaft 10 qualitatively and quantitatively.

The planetary gearbox 2, which forms a first gear stage of the drive device 100, includes the planet carrier 20, three planet gears 21, a sun gear 26, and a ring gear 27. FIG. 3 shows a first planet gear 21, namely the one above the rotational axis A, in cross-sectional view, whereas another planet gear 21 is shown in top view. The planet gears 21 are mounted on the planet carrier 20 so that they can rotate. Similarly, the planet carrier 20 is mounted so as to be rotatable about the rotational axis A via two roller bearings 4, 5. In the present case, the planet carrier 20 has bushings 25 which are inserted through holes in the planet gears 21.

The sun gear 26 for the planetary gearbox 2 is here integrated in the motor shaft 10, that is the motor shaft 10 and the sun gear 26 are formed integrally or in one piece with each other. In particular, the toothing for the sun gear 26 is formed in the motor shaft 10 via a forming process, for example a rolling process. This means that the toothing for the sun gear 26 is produced without milling, which can be recognized by the absence of milling marks. The toothing of the sun gear 26 is a helical toothing, that is, the teeth do not run parallel to the rotational axis A but are skewed to or helical around the rotational axis A.

The toothing of the sun gear 26 meshes with respective helical toothing of the planet gears 21. Rotation of the motor shaft 10 causes the planet gears 21 to rotate, which in turn causes the planet carrier 20 to rotate about the rotational axis A. The planet gears 21 roll on the fixed ring gear 27. The ring gear 27 is fixed to the housing 7, for example, and therefore does not rotate relative to the housing 7 during operation.

The use of a forming process in the manufacture of the toothing of the sun gear 26 results in a particularly smooth tooth surface. The toothing of the planet gears 21 are made of plastic, for example. The smooth surface of the sun gear 26 is particularly advantageous when plastic is used for the planet gears 21, as this keeps their wear to a minimum. Planet gears made entirely or partially of plastic are more tolerant of manufacturing tolerances and are less sensitive to tilting relative to the planet carrier 20.

In fact, a tilting moment acts on the planet gears 21, which tends to tilt the planet gears 21 relative to the planet carrier 20. This tilting moment results largely from the use of helical teeth. However, the helical teeth are advantageous in terms of high power transmission and low noise generation.

In order to minimize tilting of the planet gears 21 relative to the planet carrier 20 and to counteract it as effectively as possible, the planet gears 21 are each mounted on the planet carrier 20 in a rotatable manner via a needle bearing 22. The needle-shaped or cylindrical rolling elements 24 of the needle bearing 22 roll on the bushings 25 on one side and on sleeves 23 on the other side. The bushings 25 and the sleeves 23 are made of metal, for example. The sleeves 23 are part of the planet gears 21 and are encased or overmolded with plastic, whereby the toothing of the planet gear 21 is formed from this plastic. By reducing the relative tilt between the planet gears 21 and the planet carrier 20 due to the use of the needle bearings 22, the wear of the drive device 100 can be reduced and its performance increased.

The planet carrier 20 has a recess at an axial end facing away from the motor 1. The rotational axis A runs through this recess. In the area of the recess, the planet carrier 20 has an internal thread. A first bevel gear 30, namely a bevel pinion, of a bevel gear stage 3 is screwed into this internal thread. The bevel gear stage 3 forms a second gear stage of the drive device 100. The first bevel gear 30 has a cylindrical section with an external thread and a conical section with external teeth. The cylindrical section is screwed into the recess of the planet carrier 23, whereby the first bevel gear 30 is fastened to the planet carrier 23 and is immovable relative to the planet carrier 20, that is, it is connected to the latter in a rotationally fixed manner. The first bevel gear 30 is precisely aligned relative to the planet carrier 20 with the aid of a centering collar. The conical section protrudes axially from the planet carrier 20 away from the electric motor 1.

The first bevel gear 30 has a recess that is open in the direction of the electric motor 1 and into which the motor shaft 10 is guided. The motor shaft 10 can rotate freely within this recess. Unlike depicted in FIG. 3, the motor shaft 10 could be rotatably mounted within the recess via a bearing.

The section of the motor shaft 10 protruding into the recess of the bevel gear 30 is free of the toothing. This section forms, for example, an interface for a so-called “stand-alone” test of the electric motor 1, that is, a test in an uninstalled state.

During operation, the planet carrier 20 and the first bevel gear 30 rotate together around the rotational axis A. The bevel gear stage 3 has a second bevel gear 31 in the form of a ring gear. The second bevel gear 31 is mounted so that it can rotate about a pedal axis P, with the pedal axis P running perpendicular to the rotational axis A. The bevel gear stage 3 is therefore a 90° bevel gear stage.

The second bevel gear 31 is coupled to an output shaft 80 in the form of a hollow shaft via a freewheel 81. The output shaft 80 is part of an output 8. The output 8 also includes, for example, a chainring and/or a chainring spider (not shown), which are connected to the output shaft 80 in a rotationally fixed manner. Alternatively, the output shaft 80 may also only have an interface for a rotationally fixed coupling with the chainring or the chainring spider.

A pedal shaft 90 extends through the hollow shaft-shaped output shaft 80. The pedal shaft 90 is coupled to the output shaft 80. The pedal shaft 90 and the output shaft 80 are rotatably mounted via radial bearings 60, 61, the so-called main bearings 60, 61. When the rider of the electric bicycle pedals, the pedal shaft 90 rotates around the pedal axle P and, via a freewheel, drives the output shaft 80. The electric motor 1 exerts a torque on the output shaft 80 via the planetary gearbox 2 and the bevel gear stage 3 to assist the rider. The drive device 100 shown is an orthogonal drive.

By using a bevel gear stage 3 coupled directly to the planet carrier 20, that is without any further intermediate gear stages, the drive device 100 can be configured to be particularly compact and at the same time provides efficient speed reduction from the electric motor 1 to the output 8. However, the direct coupling between the planet carrier 20 and the bevel gear stage 3 also results in the bevel gear stage 3 exerting an axial force, a radial force, and an azimuthal force on the planet carrier 20 during operation of the drive device 100. These forces attempt to push the planet carrier 20 toward electric motor 1 and simultaneously tilt the planet carrier 20.

In order to efficiently absorb the acting radial forces, the planet carrier 20 is mounted in the housing 7 via a large radial bearing 4. The radial bearing 4 has, for example, an inner diameter of 5 cm. The radial bearing 4 is supported by the planet carrier 20.

The axial forces that occur are absorbed by an axial bearing 5. In particular, the tilting moment that acts on the planet carrier 20 results in a large axial load on the axial bearing 5. The axial bearing 5 also has a large diameter. Here, the axial bearing 5 is arranged at the outer edge or outer circumference of the planet carrier 20, that is, radially spaced apart as far as possible from the rotational axis A. In addition, elongated rolling elements, for example cylinders or cones, are used as rolling elements 50 of the axial bearing 5, whereby the load is distributed over a larger area.

In order to minimize tilting of the planet carrier 20, the axial clearance for the planet carrier 20 between the radial bearing 4 and the axial bearing 5 is kept particularly small, for example, a maximum of 0.1 mm. Among other things, this is achieved by a small tolerance chain in the axial direction. The small tolerance chain is implemented as follows: A thrust washer 51 of the axial bearing 5, on which the rolling elements 52 roll, is arranged in the axial direction directly opposite a support element, namely a radially extending part of the motor housing 70. The other thrust washer 52 of the axial bearing 5 is arranged in the axial direction directly opposite the planet carrier 20. Furthermore, the inner ring 42 of the radial bearing 4, on which the rolling elements 40 of the radial bearing 4 roll, is arranged in the axial direction directly opposite the planet carrier 20, and the outer ring 41 of the radial bearing 4 is arranged in the axial direction directly opposite a further support element, namely a part of the bottom bracket housing 71. The motor housing 70 and the bottom bracket housing 71 are connected to each other in an axially immovable manner. The elements directly opposite each other in the axial direction either adjoin each other, or spaced apart from each other at most by narrow gaps in the axial direction. In particular, the sum of the axial distances between the aforementioned directly opposite elements is less than 0.1 mm.

When the drive device 100 is installed and the motor is running, the planet carrier 20 is pressed axially toward the electric motor 1. The planet carrier 20 then abuts axially directly on the thrust washer 52, and the thrust washer 51 abuts axially directly on the motor housing 70. The small axial distances mentioned above ensure that the planet carrier 20 hardly tilts at all despite the strong tilting moment.

Another measure to reduce the tilting of the planet carrier 20 is a small radial clearance for the planet carrier 20 and the first bevel gear 30. For this purpose, the first bevel gear 30 is firmly connected to the planet carrier 20. The play of the planet carrier 20 in the radial direction is kept low by the fact that the radial bearing 4 used for the radial mounting of the planet carrier 20, which is arranged radially between the planet carrier 20 and the housing 7, abuts the planet carrier 20 with its inner ring 42 and the housing 7 with its outer ring 41 in the radial direction. No intermediate elements are used between the radial bearing 4 and the housing 7, as these could increase the play of the planet carrier 20 or the first bevel gear 30 in the radial direction. In other words, by using fewer elements in the radial tolerance chain, the radial clearance of the first bevel gear 30 and the planet carrier 20 is kept low. This means that the planet carrier 20 can only tilt to a limited extent.

Overall, the use of the radial bearing 4 and the axial bearing 5 described above helps to counteract tilting of the planet carrier 20 and to absorb the acting forces efficiently. This makes the drive device 100 particularly powerful while at the same time ensuring low wear.

Performance is further enhanced by the precise alignment of the bevel gears 30, 31 with each other. This is achieved on the one hand by the low-clearance mounting of the planet carrier 20 and the first bevel gear 30 described above, and on the other hand by a low-clearance mounting of the second bevel gear 31. For this purpose, the second bevel gear 31 is connected to the output shaft 80 in a fixed, that is, immovable, manner. The output shaft 80, in turn, is mounted via the radial bearing 60 so that it can rotate about the rotational axis P, with the radial bearing 60 being in direct contact with the output shaft 80 on the one hand and in direct contact with the cover 74 on the other. The cover 74, in turn, is firmly connected to the bottom bracket housing 71. Here too, in order to reduce the clearance of the second bevel gear 31 in the axial direction, parallel to the rotational axis A, a rotatable mounting of the second bevel gear 31 around the rotational axis P is realized with few movable elements between the housing 7 and the second bevel gear 31.

The fixed connection between the housing parts 71, 74 is a screw connection. For this screw connection, the bottom bracket housing 71 and the cover 74 have threads 710, 740 that interlock. These threads 710, 740 extend around the rotational axis P of the pedal shaft 90. The relative arrangement between the housing parts 71 and 74 is secured via fixing elements 742. The fixing elements 742 are screws in this case, which are screwed into receptacles 741 of the housing part 74. Specifically, the housing part 74 has two ring-shaped sections 743, 744, which are, in the shown cross-sectional view, by a U-shaped area of the third housing part 74, that is, they are spaced apart from each other by a gap in the direction parallel to the rotational axis P. The two sections 743, 744 each form part of the external thread 740 of the housing part 74. Longitudinal ends of the screwed-in screws 742 press the second section 744 away from the first section 743, causing the screw connection between the housing parts 71, 74 to jam and thus fixing them in their relative arrangement to each other.

The second bevel gear 31 is restricted in its movement relative to the third housing element 74 in a direction parallel to the rotational axis P via stop surfaces. The screw connection between the housing parts 71, 74 therefore allows the second bevel gear 31 to be positioned particularly accurately along the rotational axis P. The fixing of the screw connection then ensures a particularly stable position of the second bevel gear 31 in the direction of the rotational axis P. Overall, the bevel gears 30, 31 are then aligned with each other with particular precision, which benefits the performance of the entire drive device 100.

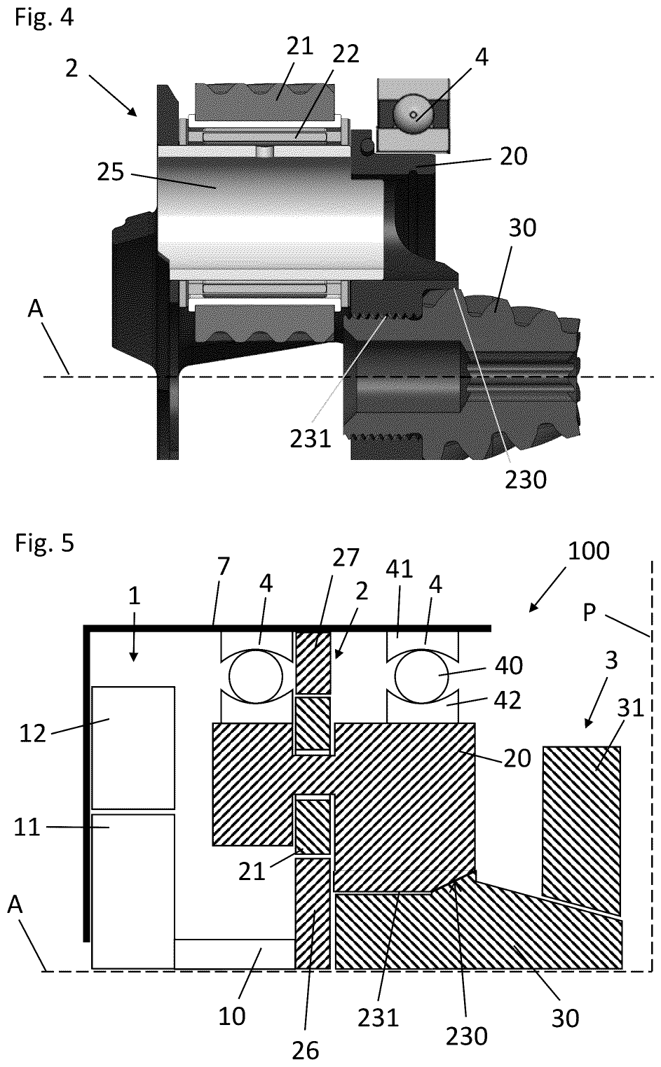

FIG. 4 shows a detail of FIG. 3. Here, it can be seen in detail how a tooth of the toothing of the first bevel gear 30 is pressed against the cylindrical centering collar 230 of the planet carrier 20, so that the first bevel gear 30 is stable and precisely centered in relation to the planet carrier 20. It can also be seen that a tool interface for coupling with a tool, for example a bit or a screwdriver, is arranged on a side of the first bevel gear 30 facing away from the planet carrier 20.

FIG. 5 shows another embodiment of the drive device 100. Unlike in FIG. 3, the centering collar 230 is not cylindrical but conical. This allows the press fit between the first bevel gear 30 and the planet carrier 20 to be easily achieved.

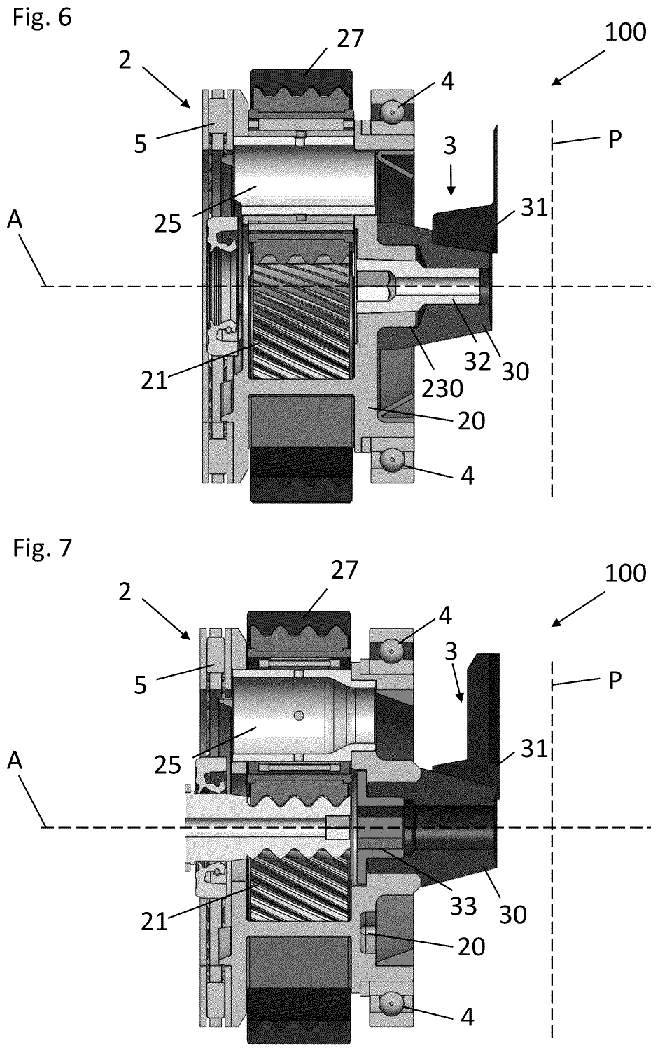

FIG. 6 shows an embodiment of the drive device 100 in which the rotationally fixed coupling between the first bevel gear 30 and the planet carrier 20 is established via an additional screw 32 or bolt 32. The screw 32 or bolt 32 is screwed into a thread in the first bevel gear 30, thereby pressing the first bevel gear 30 axially against the planet carrier 20. The planet carrier 20 and the first bevel gear 30 are centered relative to each other via a centering collar 230. The screw or bolt 32 has a conical section which is received in a conical hole in the planet carrier 20 and abuts there. When the screw or bolt 32 is tightened, the planet carrier 20 and the bevel gear 30 are connected to each other particularly firmly.

In the embodiment shown in FIG. 7, the planet carrier 20 and the first bevel gear 30 are coupled together in a rotationally fixed manner via a spline-toothing. The spline-toothing is secured by a hollow nut 33, which is screwed into the first bevel gear 30, thereby clamping the planet carrier 20 axially between the first bevel gear 30 and the hollow nut 33. The teeth of the spline-toothing each run in the axial direction.

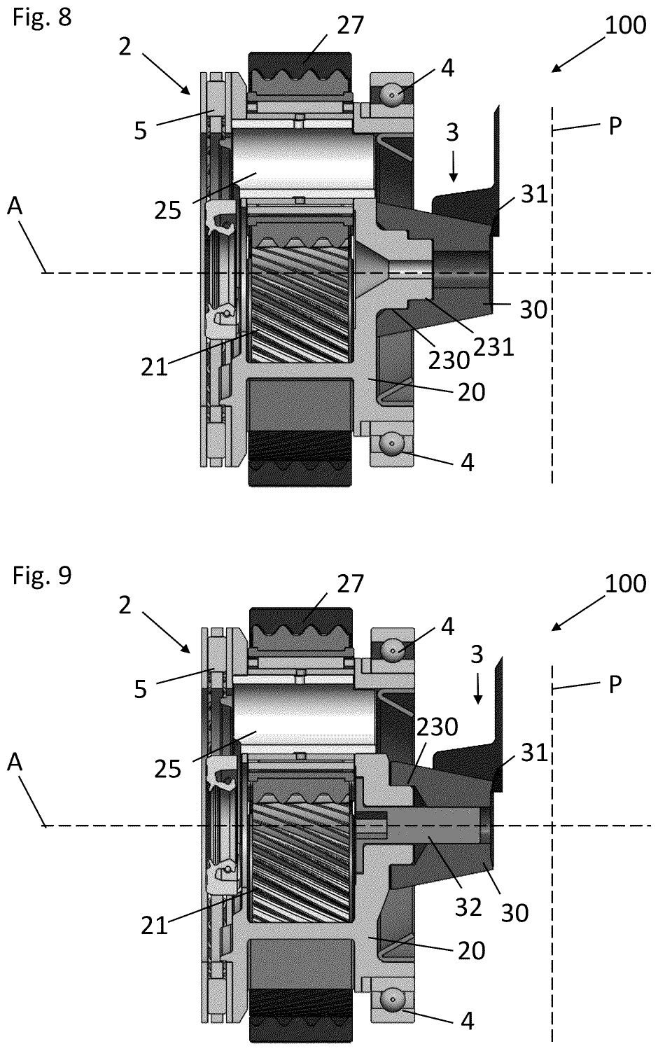

In the embodiment shown in FIG. 8, an axially protruding projection of the planet carrier 20 has two steps, one step forming the centering collar 230 and the other step having an external thread with which a direct screw connection 231 to the first bevel gear 30 is established.

In FIG. 9, unlike in FIG. 7, no spline-toothing with axially extending teeth is provided, but rather with radially extending teeth. The spline-toothing is secured by a screw 32, namely in that the planet carrier 20 is axially clamped between the head of the screw 32 and the first bevel gear 30.

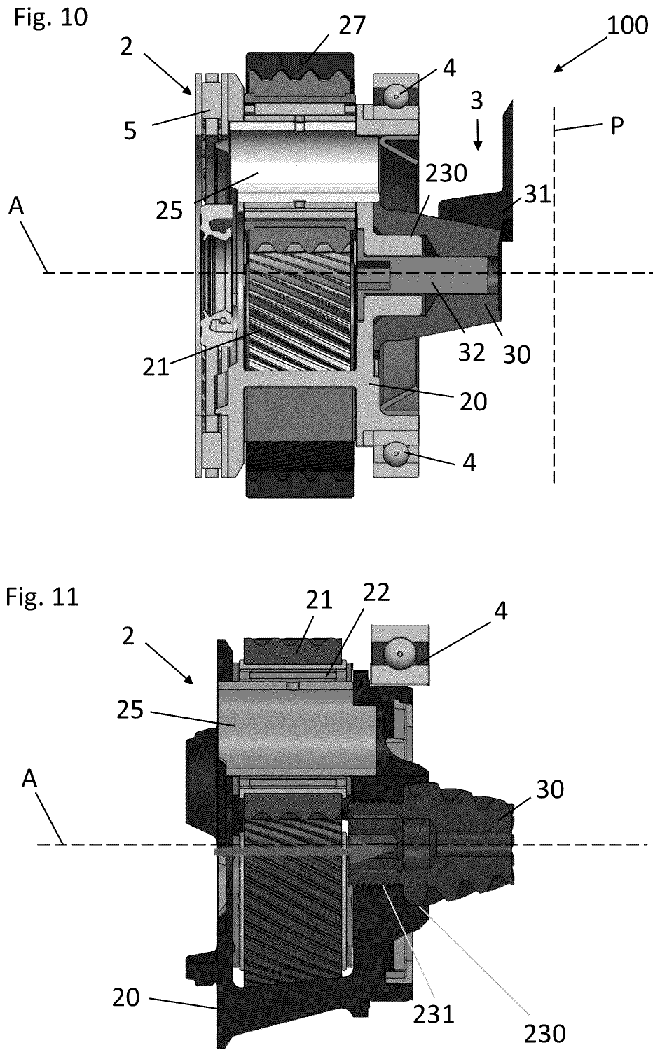

FIG. 10 shows a similar embodiment to that shown in FIG. 6. However, in this case there is also a form-fit between the first bevel gear 30 and the bushings 25 of the planet carrier 20.

FIG. 11 shows a detail of an embodiment of the drive device, which is similar to that shown in FIGS. 3 and 4. In contrast to FIGS. 3 and 4, however, the tool interface of the first bevel gear 30 is not located on the side facing away from the planet carrier 20, but on the side facing it.

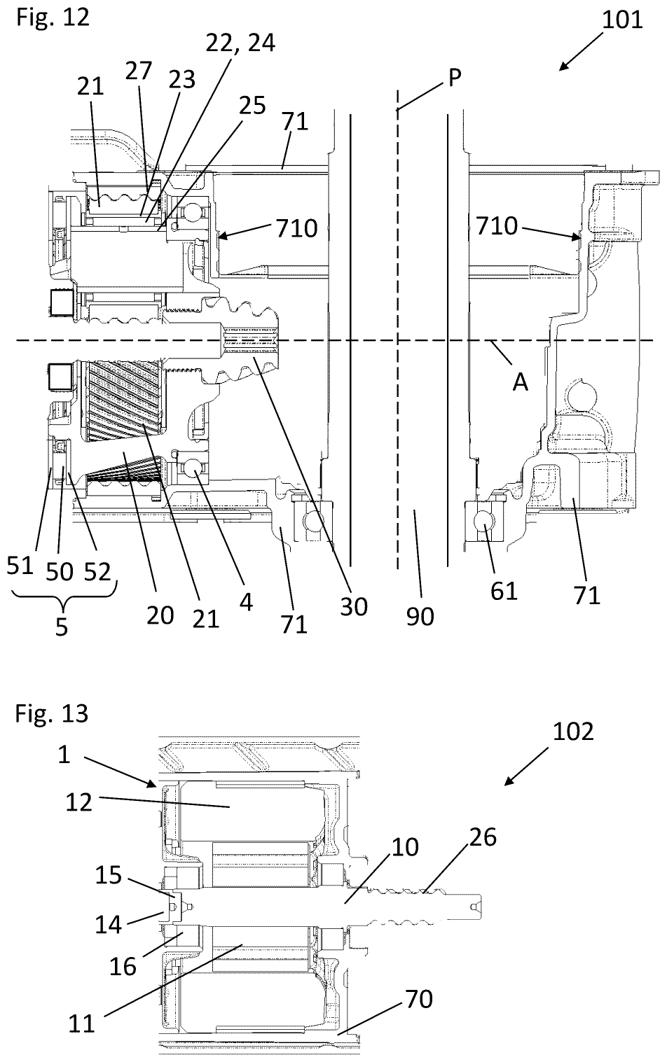

FIG. 12 shows an embodiment of the assembly 101 for the drive device of FIG. 3. The assembly 101 includes the bottom bracket housing 71 as well as the planet carrier 20 and the first bevel gear 30, which are coupled in a rotationally fixed manner to each other and are rotatably mounted via the radial bearing 4 carried by the planet carrier 20. Assembly 101 also includes the planet gears 21, which are rotatably mounted on the planet carrier 20 via the needle bearings 22. The axial bearing 5 is arranged on the side of the planet carrier 20 facing away from the first bevel gear 30. In addition, the pedal shaft 90 is inserted through the bottom bracket housing 71. The bottom bracket housing 71 is made of metal, for example. The bottom bracket housing 71 is formed in one piece and encloses both the pedal shaft 90 in the direction around the pedal axis P and the planet carrier 20 in the direction around the rotational axis A.

FIG. 13 shows an embodiment of a further assembly 102 for the drive device 100 of FIG. 3. The assembly 102 includes the motor housing 70, in which the electric motor 1 with the associated motor shaft 10 is accommodated.

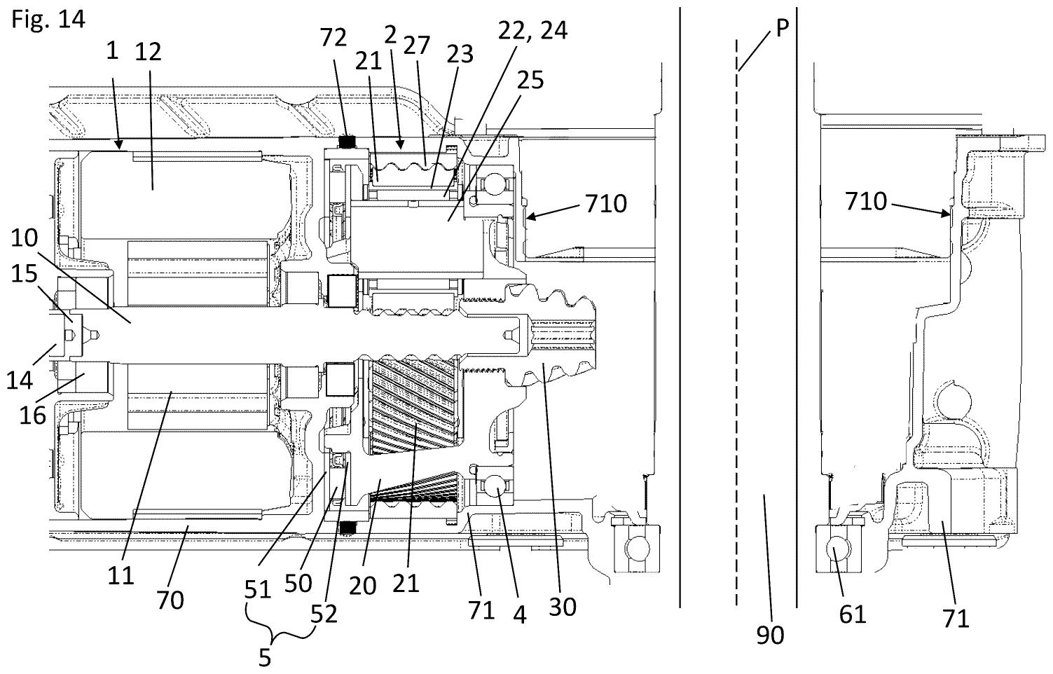

To assemble the drive device 200 of FIG. 3, the assembly 102 is first connected to the assembly 101. The resulting device is shown in FIG. 14. During connection, the motor shaft 10 is pushed through the planet carrier 20 into the receptacle of the first bevel gear 30. In addition, the thrust washer 51 is arranged axially directly opposite a radially extending section of the motor housing 70. The dimensions of the individual elements are selected so that there are no or only small air gaps in the axial direction between the housing sections on which the bearings 4, 5 can be axially supported.

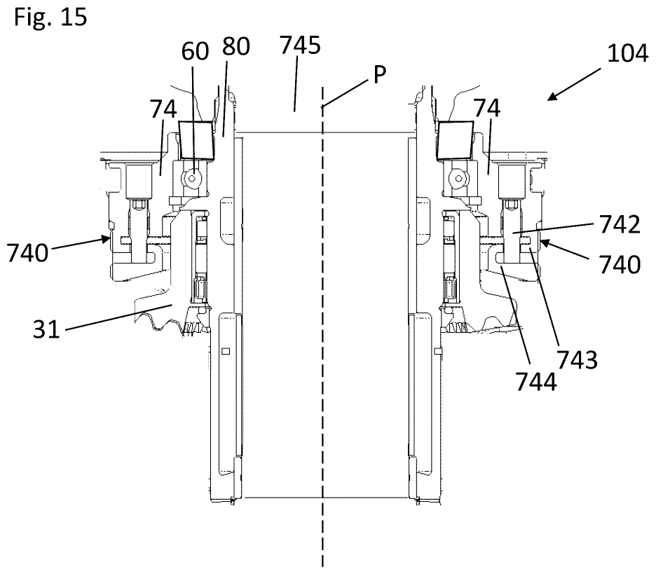

FIG. 15 shows an embodiment of the further assembly 104 for assembling the drive device 100 of FIG. 3. The assembly 104 includes the housing part 74. The fixing elements 742 in the form of screws are already inserted into the receptacles 741 of the housing part 74, but only to the extent that the sections 743, 744 are not yet clamped with respect to each other. The assembly 104 also includes the bevel gear 31, the output shaft 80, and the radial bearing 60. The bevel gear 31 and the output shaft 80 are mounted via the radial bearing 60 so that they can rotate about the rotational axis P.

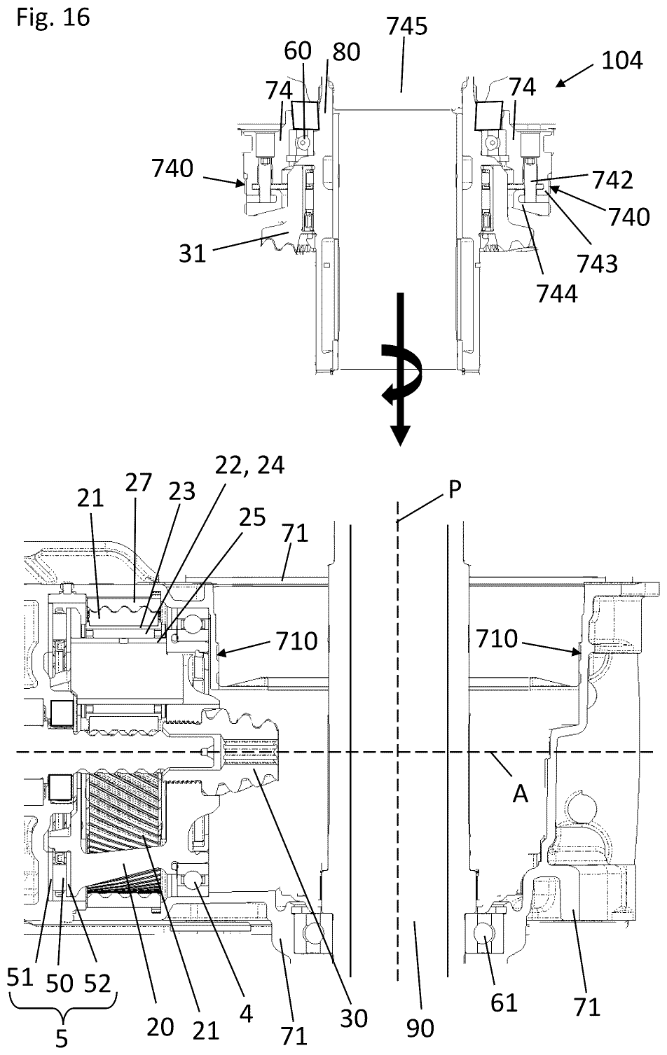

To assemble the drive device, the assembly 104 shown in FIG. 15 is now screwed onto the device shown in FIG. 14 (see FIG. 16). To do this, the pedal shaft 90 is pushed through the feedthrough 745 in the housing part 74. The housing parts 74, 71 are screwed together until the positioning of the bevel gears 30, 31 is adjusted as desired in a direction parallel to the rotational axis P. The screws 742 are then tightened, thereby clamping the sections 743, 744 against each other and thus locking the screw connection between the housing part 74 and the housing part 71. In this way, the bevel gears 30, 31 can be fixed in their relative position parallel to the rotational axis P.

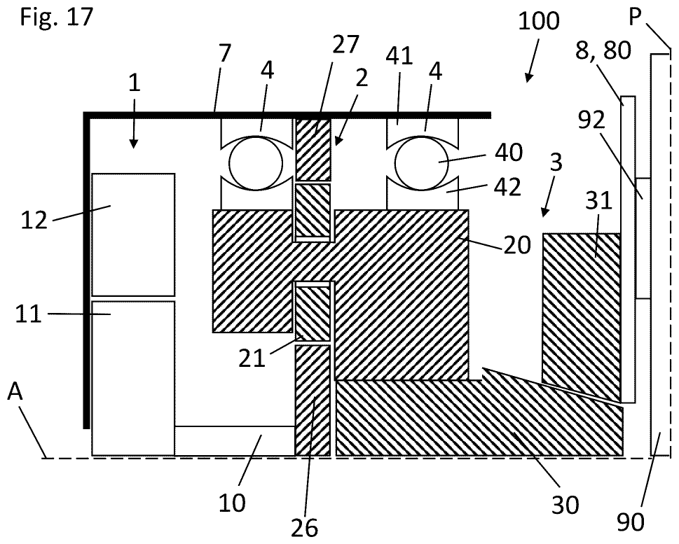

FIG. 17 shows an embodiment of the drive device 100, which differs from that shown in FIG. 2 in that there is no screw connection between the planet carrier 20 and the first bevel gear 30. Instead, the pin-shaped section of the first bevel gear 30 is embedded in the planet carrier 20 and thus conformably enclosed by it. The planet carrier 20 is a primary shaped part, such as a cast part. The centering collar can be omitted.

It is understood that the foregoing description is that of the preferred embodiments of the invention and that various changes and modifications may be made thereto without departing from the spirit and scope of the invention as defined in the appended claims.

### LIST OF REFERENCE SYMBOLS

1 electric motor
2 planetary gearbox
3 bevel gear stage
4 Radial bearing
5 axial bearing
7 housing
8 output
10 motor shaft
11 rotor
12 stator
14 magnet
15 adapter for magnet
16 motor bearing
20 planet carrier
21 planet gear
22 needle bearing
23 outer sleeve
24 rolling element
25 bushing/bolt
26 sun gear
27 ring gear
30 first bevel gear/bevel pinion
31 second bevel gear/ring gear
40 rolling element
41 outer ring
42 inner ring
50 rolling element
51 thrust washer
52 thrust washer
60 radial bearing
61 radial bearing
70 motor housing
71 bottom bracket housing
72 sealing sleeve
74 cover
80 output shaft
81 freewheel
90 pedal shaft
92 freewheel
100 drive device
101 assembly
102 assembly
104 assembly
110 bicycle frame
120 down tube
200 electric bicycle
710 thread
740 thread
741 receptacle
742 fixing element/screw
743 first section
744 second section
745 feedthrough
A rotational axis
P pedal axle/rotational axis
32 screw or bolt
33 nut/hollow nut
230 centering collar
231 screw connection

1. A drive device for an electric bicycle, the drive device comprising:
a planetary gearbox with a planet carrier;
a bevel gear stage with a first bevel gear;
said planet carrier and said first bevel gear being coupled to each other in a rotationally fixed manner;
said planet carrier and said first bevel gear being mounted rotatably about a rotational axis via a radial bearing; and,
said radial bearing being supported by said planet carrier.

2. The drive device of claim 1, wherein a section of said first bevel gear is embedded in said planet carrier.

3. The drive device of claim 1, wherein said planet carrier and said first bevel gear are directly connected to each other via a screw connection.

4. The drive device of claim 3, wherein said first bevel gear has an external thread for said screw connection and said planet carrier has an internal thread for said screw connection.

5. The drive device of claim 1, wherein said first bevel gear is centered relative to said planet carrier via a centering collar.

6. The drive device of claim 5, wherein said planet carrier and said first bevel gear are directly connected to each other via a screw connection; said first bevel gear has an external thread for said screw connection and said planet carrier has an internal thread for said screw connection; and, a diameter of said centering collar is larger than a diameter of said internal thread of said planet carrier for said screw connection.

7. The drive device of claim 6, wherein said centering collar is arranged axially between an interface of said screw connection and a further interface between said first bevel gear and a second bevel gear.

8. The drive device of claim 5, wherein said centering collar is conically shaped at least in sections.

9. The drive device of claim 5, wherein said planet carrier and said first bevel gear are press-fitted together in an area of said centering collar.

10. The drive device of claim 1, wherein said radial bearing is arranged in a radial direction at least in sections at a same height as a ring gear of said planetary gearbox.

11. The drive device of claim 1 further comprising a housing; and, said radial bearing being coupled both directly to said planet carrier and directly to said housing.

12. The drive device of claim 1 further comprising an axial bearing via which said planet carrier and said first bevel gear are rotatably mounted.

13. The drive device of claim 12, wherein said radial bearing is arranged axially between said axial bearing and a second bevel gear of said bevel gear stage.

14. The drive device of claim 12, wherein an inner diameter of said radial bearing is larger than an inner diameter of said axial bearing.

15. The drive device of claim 13, wherein an inner diameter of said radial bearing is larger than an inner diameter of said axial bearing.

16. The drive device of claim 1 further comprising:
an electric motor;
an output; and,
said electric motor being coupled to said output via said planetary gearbox in order to transmit torque from said electric motor to said output.

17. An assembly for an electric bicycle, the assembly comprising:
a planet carrier for a planetary gearbox;
a first bevel gear for a bevel gear stage;
said planet carrier and said first bevel gear being coupled to each other in a rotationally fixed manner;
said planet carrier and said first bevel gear being mounted rotatably about a rotational axis via a radial bearing; and,
said radial bearing being supported by said planet carrier.
